(19) United States
(12) Patent Application Publication
(10) Pub. No.: US 2014/0140812 A1
(43) Pub. Date: May 22, 2014

(54) TILTING BLADE SYSTEM FOR VERTICAL-AXIS WIND AND WATER TURBINES FOR MINIMAL DRAG, HIGH EFFICIENCY & MAXIMUM POWER OUTPUT

(71) Applicant: Paul M. Swamdass, Auburn, AL (US)

(72) Inventor: Paul M. Swamidass, Auburn, AL (US)

(21) Appl. No.: 14/166,061

(22) Filed: Jan. 28, 2014

Related U.S. Application Data
(63) Continuation-in-part of application No. 13/429,375, filed on Mar. 24, 2012, now Pat. No. 8,459,020.
Application No. 13/429,375 is a continuation-in-part of application No. 13/964,038, filed on Aug. 10, 2013.
Application No. 13/964,038 is a continuation-in-part of application No. PCT/US2013/031334, filed on Mar. 14, 2013.
Application No. PCT/US2013/031334 is a continuation-in-part of application No. 13/984,498, filed on Aug. 8, 2013.

(51) Int. Cl. F03B 7/00

(52) U.S. Cl. CPC F03B 7/00
USPC 415/7

(57) ABSTRACT

Certain vertical-axis wind and water turbine blades suffer from drag that reduces the turbine's torque and turbine-generated power. Significant drag is generated when the blade is turning upstream on the return side of the turbine. This invention is a blade system that reduces upstream (return) side drag to almost nothing by enabling the turbine blade to tilt or swivel to eliminate almost all fluid resistance to the blade on the upstream side. The result is much increased turbine efficiency, increased torque and power from vertical-axis wind or water turbines. The increased power resulting from this innovative turbine blade system enables the use of gearboxes to increase the RPM of vertical axis turbines for electricity generation, and also enables easier self-starting. Easier to manufacture turbine blades use linear approximations for the curved sections of modified Savonius blade profile.

### CROSS-REFERENCE TO RELATED APPLICATIONS AND CLAIMS TO PRIORITY

This is a continuation-in-part of, and claims priority commonly assigned to U.S. patent application Ser. No. 13/429,375 filed on Mar. 24, 2012, now U.S. Pat. No. 8,459,020, issued Jun. 11, 2013; application PCT/US2013/031334 filed on Mar. 14, 2013 filed through the USPTO—the receiving office; USPTO application Ser. No. 13/964,038 filed on Aug. 10, 2012; and U.S. patent application Ser. No. 13/984,498 filed on Aug. 8, 2013; the entire disclosure of which is incorporated herein by reference.

### DESCRIPTION

1. Field of Invention

This invention relates to turbine devices, particularly the vertical-axis turbines to extract usable energy from flowing wind, water and other fluids.

2. Background of Invention

U.S. Pat. No. 7,696,635 teaches at length about vertical-axis turbines that have vanes or blades mounted radially outward from a vertical shaft. They convert the energy in linearly flowing wind or water into rotational power.

One form of this turbine is called the Savonius-type wind turbine (U.S. Pat. No. 1,697,574) that continues to evolve through university research and new patents. While the classic Savonius wind turbine had two vanes with an open central axis to allow cross-flow of wind from one vane to the other, later designs with more blades have done away with the cross flow of wind between blades (U.S. Pat. No. 7,696,635),

Savonius-type devices suffer energy losses attributable to “drag.” There is constant drag caused by the blades moving against wind or water on the upstream side of the rotor. This drag considerably reduces the efficiency of this type of turbines. Several patents have attempted to solve this problem, including U.S. Pat. Nos. 4,494,007, 5,642,983, 6,126,385, 6,655,916, 6,682,302; 6,740,989, 7,094,017, 7.696,635, etc. This growing list of patents in recent years reveals the challenge posed by the need to improve the efficiency of these turbines, and confirm the incomplete success in tackling the efficiency of these turbines.

Because Savonius turbines are limited to maximum tip speeds equaling the ambient velocity of the wind or water, they would need a gearbox to increase rotor speed fit for electric energy production. Reducing the drag and Increasing the efficiency of these turbines has the added advantage of having more power in the rotor shaft to employ a gearbox to increase the RPM in the drive train for producing electricity.

### BRIEF SUMMARY OF THE INVENTION

Drag-based, vertical-axis wind and water turbines have a maximum blade tip speed about the same as the ambient flowing wind or water. If the velocity of the blade is exactly the same as the wind speed, the blade tip speed ratio (TSR) is 1. In this invention, to increase the power of the turbine, the resistance to the blade (or drag) on the upstream side (return side) of the turbine is almost eliminated by superior blade design that is tilted or swiveled by the flowing air or water on the upstream side to a horizontal position to offer little or no resistance to the turning blade.

The blade system of this invention tilts and swivels freely on an horizontal axis. On the downstream side, blades recover to the vertical position by gravity or by the use of spring action, hydraulic systems, or by electro-mechanical systems. The height of the turning axis of the blade can be adjusted to different distances above the bottom of the blade to vary the force needed to tilt the blade.

This invention for wind and water turbine does not use rigidly mounted blades on the turbine rotor shaft. Instead, it uses a plurality of horizontal blade-mounting spokes of round cross-section that radiate from the turbine rotor. Each spoke supports a turbine blade that is capable of tilting & swiveling with the blade-mounting spoke serving as the horizontal turning axis.

Further, the rotor shaft has the same number of blade-stop spokes under each blade-mounting spoke on the same vertical plane as the blade-mounting spokes. Water pressure on the downstream side press the turbine blades firmly against the blade-stop spokes to hold the blades in the vertical position to capture energy from flowing wind or water on the downstream side and convert it into rotary power that could be used for electric energy production or for any other use.

On the upstream side, water pressure would tilt the blade to a substantially horizontal position to allow the water to flow through without resistance. The result is near maximum net energy captured from wind or water because of near zero drag on the upstream side of the turbine. The additional net power could be used to increase the RPM of the turbine shaft by using a gearbox. Higher RPM from the vertical-axis turbine enables increased electric energy production.

### PREFERRED EMBODIMENT

### Brief Description of the Drawings

FIG. 1: A perspective of the turbine with only two blades where one blade is held vertical on the downstream side and another is substantially tilted to a horizontal position to offer no resistance to the flowing wind or water on the upstream side.

FIG. 2: Top view of the device where one blade is positioned vertically on the downstream side, and another is tilted to a horizontal position on the upstream side.

FIG. 3: Side view from the upstream side where the blade is tilted by the flowing wind or water.

FIG. 4: Side view of the blade from the downstream side where the blade is positioned vertically by the pressure applied by the flowing wind or water.

FIG. 5: A perspective of a water turbine with two blades attached to a cylindrical float slidably attached to a central turbine rotor shaft.

FIG. 6: A perspective of a water turbine with two blades with a float slidably attached to the turbine rotor shaft under the blades.

FIG. 7: A cross-section of a turbine blade with linear approximations to the modified Savonius blade.

### DETAILED DESCRIPTION OF PREFERRED EMBODIMENT

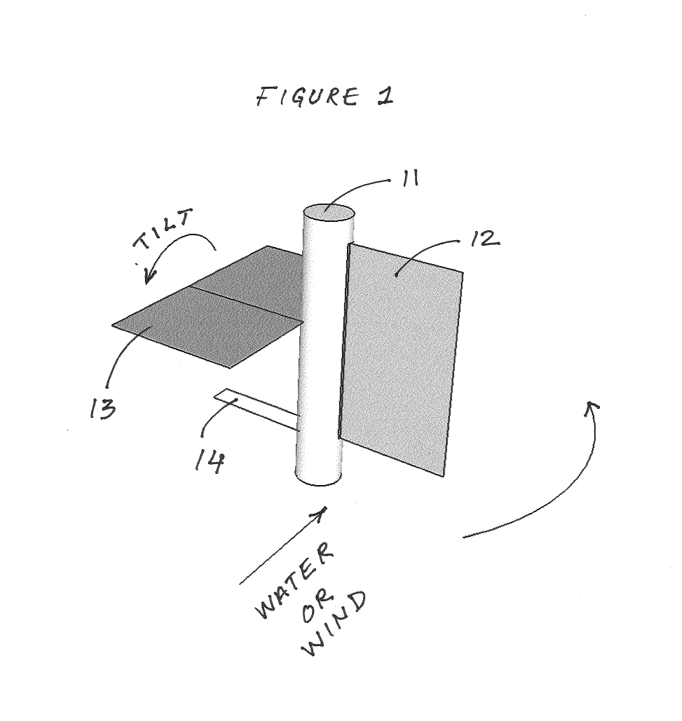

FIG. 1 shows a perspective of a two-bladed vertical-axis turbine, where drive shaft (or rotor) 11 is turned anticlockwise by the energy in the flowing wind or water acting on blade 12 on the downstream side, which is positioned vertically by gravity or a by power-assisted mechanism. Both identical blades 12 and 13 can tilt on an horizontal spoke (not shown) attached rigidly to the drive shaft 11. Blade 13, on the upstream side, is shown tilted to an horizontal position by the flowing wind or water. The tilting blade 13 reveals the blade-stop 14, which stops the blades from tilting beyond the vertical position on the downstream side.

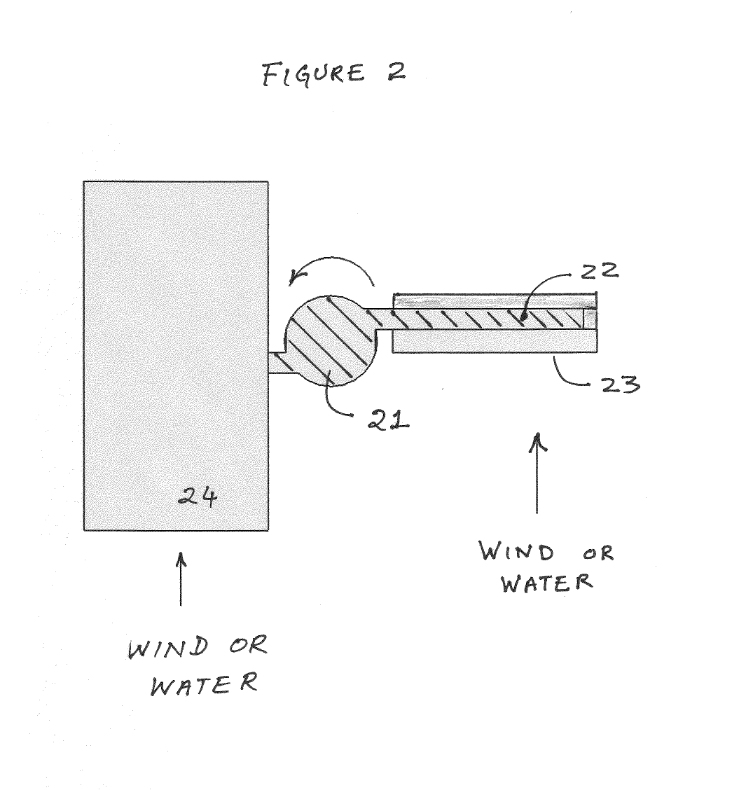

FIG. 2 is a top view that shows two identical blades 23 and 24. FIG. 2 is a cross-sectional view showing the drive shaft 21 with a rigidly attached blade-mounting spoke 22, on which blade 23 is mounted in a such a manner that the blade can tilt or swivel freely around spoke 22. Blade 23 is shown in the vertical position on the downstream side so that flowing wind or water can move blade 23 counterclockwise around the drive shaft while transmitting torque/power to the drive shaft 21 through blade-mounting spoke 22. On the upstream side, blade 24 is tilted to an horizontal position by the forces in the flowing wind or water so that blade 24 faces minimal resistance or drag while turning on the upstream side because wind or water flow above or below the horizontally positioned blade 24. Tilted blade 24 maximizes the net torque and power transmitted by blade 23 to the rotor and increases the efficiency of the turbine.

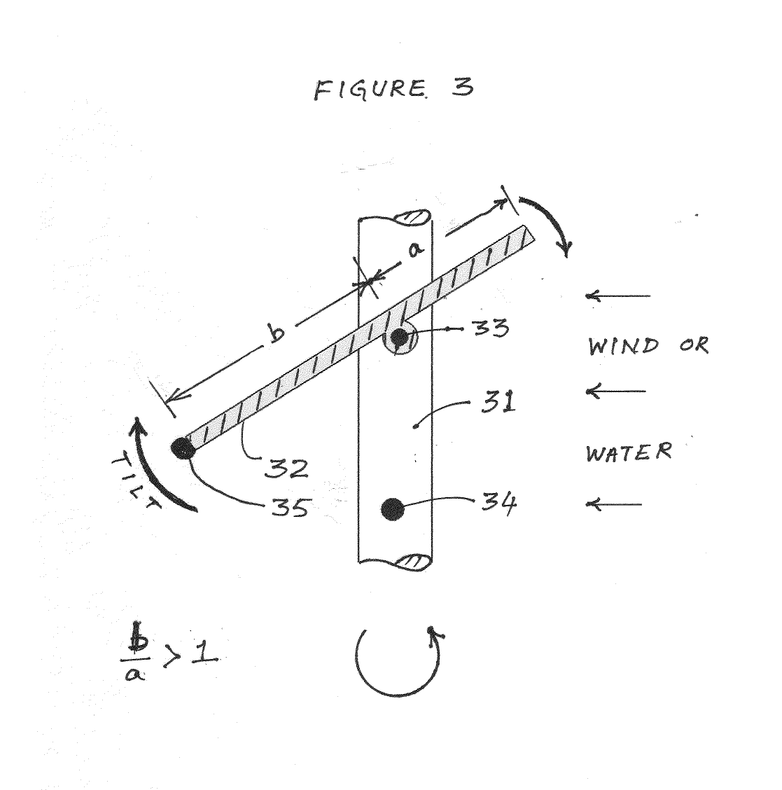

FIG. 3 is the upstream-side view of the turbine, where blade 32 is shown partially tilted around the horizontal spoke 33 that is rigidly and radially attached to rotor 31. Blade-stop spoke 34, mounted radially but in the same vertical plane below spoke 33, acts as a blade-stop to hold the blade in a vertical position on the downstream side with flowing wind or water pressing the blade against spoke 34. Weight 35 may be added to the blade at the bottom of the blade to optimize the tilt and recovery from tilt during each rotary cycle of the blade around the drive shaft.

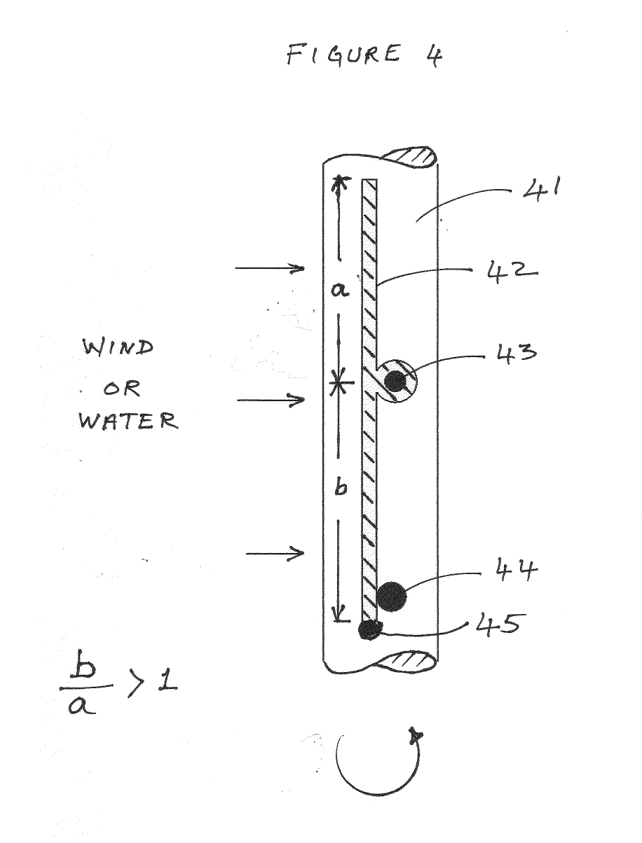

The placement of the blade-tilt axis above the bottom edge of the blade affects dimensions “a” and “b” in FIGS. 3 and 4. For a gravity-based operation of the blade, where the blade is un-weighted, b>a, or the ratio b/a>1. When b=a, or “b” is nearly equal to “a,” the blade may experience instability and may not recover to the vertical position on the downstream side of the turbine by gravity. The force needed to dislodge the blade from its gravity-operated vertical position is a function of: the ratio b/a, the density of the fluid in which the turbine is operating, the velocity of the fluid, and the rpm of the turbine. By addition weight 35 to the blade at the bottom as well as other locations on the blade, the blade tilt and recovery can be managed and controlled.

FIG. 4 shows the downstream-side view of the turbine, where blade 42 can tilt on horizontal blade-mounting bar 43 that is rigidly and radially attached to the rotor 41. The energy in the wind or water is captured by blade 42 in the vertical position and transferred to the rotor shaft by spokes 42 and 43 that are attached radially to the rotor. Optional weight 45 is shown attached to the bottom of blade 42. Optional weight enables the control of blade tilt and its recovery from tilt while the turbine is operating.

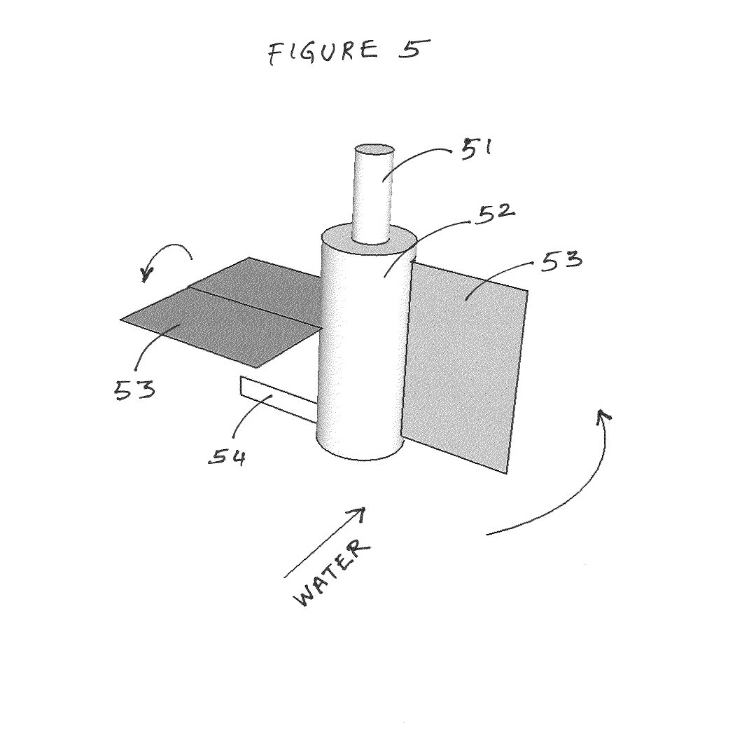

FIG. 5 shows a water turbine with two blades 53 attached to a cylindrical float 52 by blade-mounting spokes in FIGS. 3 and 4. Cylindrical float 52 is slidably attached to rotor drive shaft 51 such that water energy acting on the turbine blade on the downstream side turns the float counterclockwise. The float transmits the counterclockwise rotation to the rotor drive shaft. In the figure, 54 is the blade-stop spoke that holds the blade in the vertical position on the downstream side. The float displacement is designed to enable the turbine blade assembly to operate at or near the surface of the water.

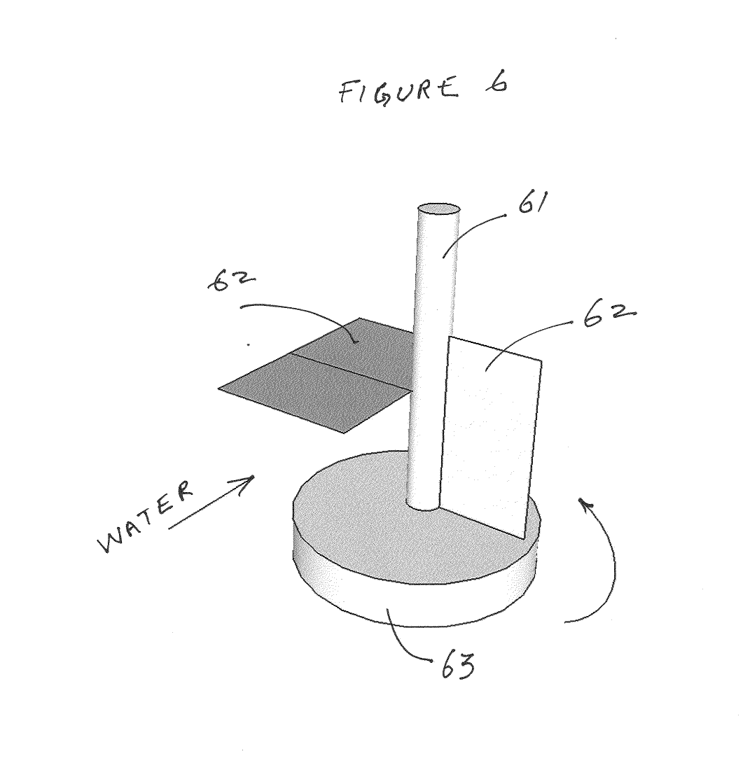

FIG. 6 shows a water turbine with two blades 62 attached to a central rotor drive shaft 61. Float 63 is mounted slidably on the central rotor drive to move up and down with the blade assembly system. The float displacement is designed to enable the turbine blade assembly to operate at or near the surface of the water.

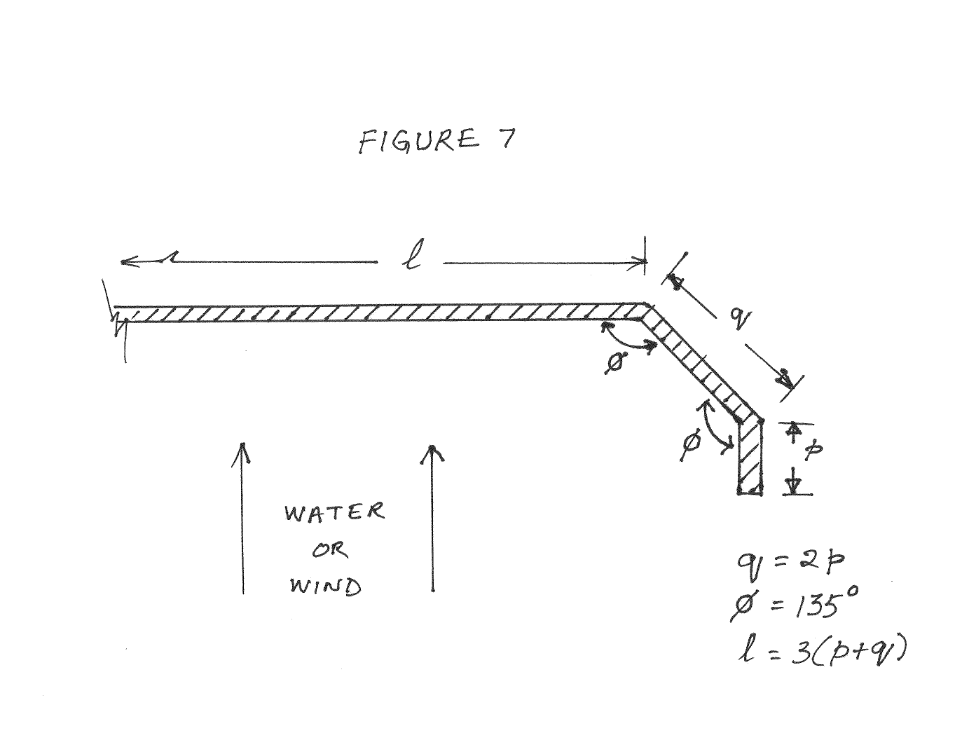

FIG. 7 shows a cross-section of a turbine blade that uses linear approximations to the curved portions of the modified Savonius turbine blade. The linear approximations of curved profiles are easier to manufacture, reduce manufacturing cost, and capture most energy from flowing wind or water. Examples of modifications to Savonius Turbine blades are found in U.S. Pat. No. 4,715,776 A; U.S. Pat. No. 4,830,570 A; U.S. Pat. No. 4,784,568 A; U.S. Pat. No. 4,838,757 A; U.S. Pat. No. 5,494,407 A; U.S. Pat. No. 7,008,171 B1; U.S. Pat. No. 7,980,825 B2; U.S. Pat. No. 8,569,905 B2; US 20110206526 A1; however they do not use linear approximations for complex curved blade profiles.

1. A vertical-axis wind or water turbine for converting energy in wind and flowing water comprising:
a. a vertical-axis turbine rotor shaft with a plurality of radial blades (or vanes) disposed for rotation;
b. rotor blades tiltably mounted on horizontal blade-supporting spokes radiating perpendicularly outward from the rotor shaft;
c. a blade-stop spoke below the blade-mounting spoke radiating perpendicularly from the rotor shaft mounted rigidly on the rotor on the same vertical plane as the blade-supporting spoke above it, the tiltable blade rests in a vertical position on the blade-stop when pressed against it by the pressure exerted by the wind or flowing water on the downstream side of the rotor shaft to capture the energy in the moving fluid and to convert it to rotary motion;
d. turbine blades that tilt substantially to an horizontal position on the upstream side of the rotor shaft in order to offer nearly zero drag resistance to the turning rotor shaft thereby maximizing turbine efficiency, net torque and power produced by the turbine;
e. turbines tilt and recover from tilt entirely by gravity or by spring action, hydraulic or electromechanical assist;
f. turbine blades with profiles created with linear approximations for the curved sections of the modified Savonius blade profile to simplify the manufacturing process, to reduce the cost of manufacturing the blades, and to capture most energy from moving wind or water; and
g. a float of appropriate displacement in water applications to provide buoyancy to the blades assembly to make it float near the surface of the water; wherein,
1. the float is attached slidably on the turbine rotor shaft above or below the turbine blades, or
2. the float, with blades attached to is outer vertical surface, surrounds the rotor and transmits rotary power from the blades to the rotor.

2. The turbine and blades system as recited in claim 1 produced in stackable modules of fixed height, wherein, modules stacked one-over-the-other turn a common rotor drive shaft for multiplying the power output.

3. The water turbine and blades system as recited in claim 1, without the use of a float, may be installed submerged well below the water surface for energy production from water currents, tides, and flowing water.
